(19) United States
(12) Patent Application Publication
(10) Pub. No.: US 2004/0206377 A1
(43) Pub. Date: Oct. 21, 2004

(54) Sound insulation for dishwashers

(75) Inventors: Rowland Griffin, Pocono Summit, PA (US); John P. Field, Columbia, NJ (US)

Correspondence Address: SHOEMAKER AND MATTARE, LTD, 10 POST OFFICE ROAD - SUITE 110, SILVER SPRING, MD, 20910, US

(73) Assignee: Monadnock Non-wovens LLC, Mount Pocono, PA

(21) Appl. No.: 10/414,498

(22) Filed: Apr. 16, 2003

(51) Int. Cl. B08B 3/02

(52) U.S. Cl. 134/56 D; 134/57 D; 134/58 D; 134/200; 134/201

(57) ABSTRACT

Sound insulation core material is made by melt-blowing a polypropylene resin having a hydroxystearamide wax additive to produce a fibrous mass having improved loft. The core material is encased between outer layers of spun-bond polyethylene fibers by longitudinal seams and transverse seams to form a product suitable for use in dishwashers.

### BACKGROUND OF THE INVENTION

This invention relates to a sound insulation for dishwashing machines.

Dishwashers generate considerable noise, both from operation of the motor and other mechanical moving parts, and from the impact of water on the interior of the dishwasher, and on the dishes. Dishwashers therefore have sound insulation to reduce the amount of noise which reaches the kitchen to acceptable levels.

The production cost of a dishwasher includes the cost of insulation, and the weight of the insulation is a consideration as well. Therefore, it is desirable to reduce the cost and weight of the insulation in a dishwasher.

Prior patents in the field of this invention include U.S. Pat. Nos. 4,042,740, 5,298,694 Reissued as Re. 36323); U.S. Pat. Nos. 6,217,691, 6,220,388, 6,358,592, 6,364,647, 6,371,749 and Japanese Patents 9095169 and 9076387.

We have observed some problems with product quality and fiber lofting in a current sound insulation made of polypropylene fibers, arranged in a “SMS” (spun bond—melt blown—spun bond) laminate.

### SUMMARY OF THE INVENTION

An object of the invention is to improve sound insulation of dishwashers and other machines.

Another object is to reduce the weight and cost of such insulation.

It is also an object of the invention to provide sound insulation, made of polypropylene fibers, which has as much loft as possible, and a density not greater than about 1.5 lb/ft^{3.}

These and other objects are attained by producing polypropylene sound insulation by adding a hydroxystearamide wax, preferably Paracin 285 (N,N′ethylene-bis-12-hydroxy-stearamide, CasChem. Inc., Bayonne, N.J.) to the melted polypropylene resin in such a way that it blooms to the surface of the fibers when they are produced by melt blowing. The amount of Paracin is not more than 1% of the weight of the resin, preferably 0.4% to 0.6%. The consequent reduction of thermal bonding at the surface of the fibers produces improved loft.

### BRIEF DESCRIPTION OF THE DRAWINGS

In the accompanying drawings,

FIG. 1 is an isometric view of an indefinite length of sound insulation embodying the invention;

FIG. 2 is cross-sectional view thereof, taken on a plane parallel to the length of the insulation; and

FIG. 3 is a graph showing sound attenuation characteristics of the insulation.

### DESCRIPTION OF THE PREFERRED EMBODIMENT

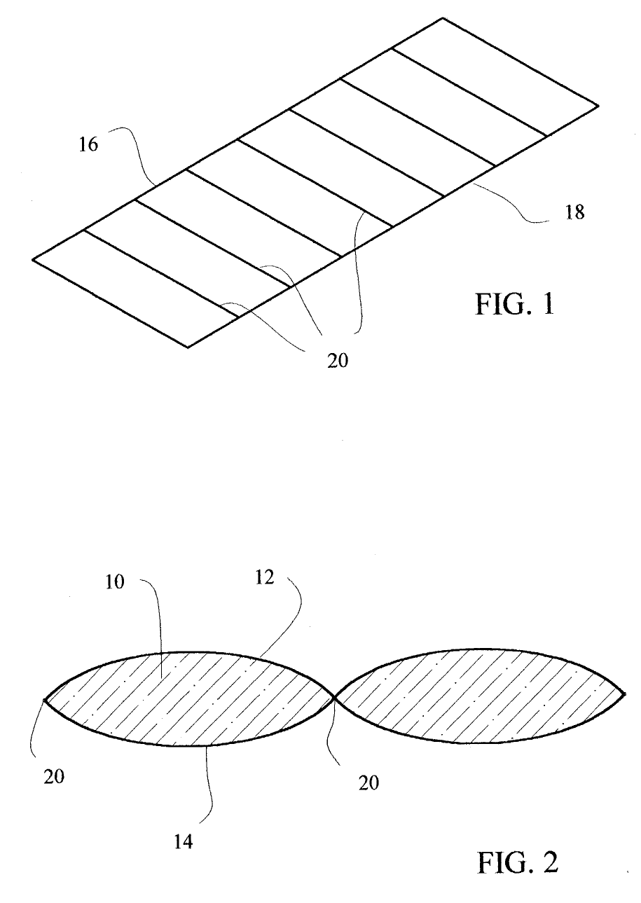

As shown in FIGS. 1 and 2, an indefinite length of sound insulation according to the invention comprises a series of cells each containing a fibrous core layer 10 contained between outer layers 12 and 14, shown in FIG. 2. The outer layers are preferably spun-bond polypropylene. The core is made of melt-blown polypropylene fibers using standard equipment. The layers are united at the longitudinal edges by longitudinal seams 16, 18, and preferably also by transverse seams 20 at regular intervals. Examples 2 and 3 below embody the invention.

To achieve high loft and low density, a hydroxystearamide wax, preferably Paracin 285 (N,N′ethylene-bis-12-hydroxy-stearamide, CasChem. Inc., Bayonne, N.J.) is added to the melted polypropylene resin prior to extrusion of the fibers, so that he wax blooms to the surface of the fibers when they are produced in a melt blowing process.

### EXAMPLE 1

To provide a basis for comparison, a layer of meltblown polypropylene was made by extruding Sunoco CP15000P resin through an array of 2160 holes each having a diameter of 0.014 inch at a temperature of 230° C. and a pressure of 200 psi, discharging into air at ambient conditions onto a surface moving at 20 ft/min. The resulting product was tested and found to have the properties in the table below.

| | |
|---|---|
| Layer thickness: | 0.25 inch |
| Basis weight: | 33 g/ft² |
| Density: | 3.5 lb/ft³ |
| Average fiber diameter: | 2-4 micron |
| Fiber diameter range: | 0.5-10 micron |
| Sound attenuation: | Unacceptable |

### EXAMPLE 2

A second layer of meltblown polypropylene was made be a process identical to that of Example 1, except that 0.6% Paracin 285 was added to the resin before extrusion. The following properties resulted:

| | |
|---|---|
| Layer thickness: | 0.50-0.75 inch |
| Basis weight: | 33 g/ft² |
| Density | 1.5 lb/ft³ |
| Average fiber diameter: | 2-4 micron |
| Fiber diameter range: | 0.5-10 micron |
| Sound attenuation: | Excellent |

The sound attenuation in each example was determined by ASTM E1050-98 “Standard Test Method for Impedance and Absorption of Acoustical Materials”.

We had originally thought that it would be necessary to reduce the MFR (melt flow rate) to improve loft, and that longer molecular chains would be needed to produce a springy product; however, we were surprised to find that, in Example 2, even with a high MFR (1500 lbs/hr), the Paracin additive produced both better production rates and better loft.

### EXAMPLE 3

The product of Example 2 was sandwiched between two layers of spun-bond polypropylene. The layers were connected by thermally seaming at the lateral edges of the product, and by making transverse seams, extending across the product, at intervals of six inches. The seams were created by applying pressure against an anvil roll in the machine direction.

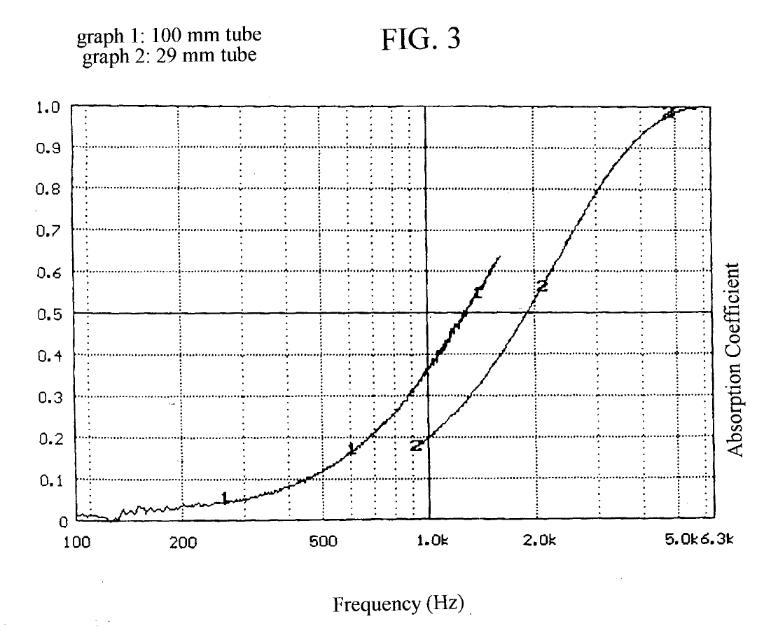

The sound absorption spectrum of the finished product is illustrated in FIG. 3.

Although the invention has been described as dishwasher insulation, we expect it may be useful for other appliances and other fields, for example, in automobiles.

Since the invention is subject to modifications and variations, it is intended that the foregoing description and the accompanying drawings shall be interpreted as only illustrative of the invention defined by the following claims.

I claim:

1. Sound insulation for dishwashers comprising a core layer of melt-blown polypropylene fibers having a density not greater than 1.5 lb/ft³.

2. The insulation of claim 1, further comprising a pair of outer layers, one on each side of said core layer, each of said outer layers being made of melt-blown polypropylene fibers.

3. The insulation of claim 2, wherein the core and the outer layers are interconnected by seams along their longitudinal edges.

4. The insulation of claim 3, wherein the core and the outer layers are interconnected by transverse seams extending between said longitudinal seams.

5. The insulation of claim 4, wherein said transverse seams are formed at regular intervals of about six inches.

6. The insulation of claim 1, wherein the core layer is made by adding a wax additive to polypropylene resin before producing the fibers by melt blowing.

7. The insulation of claim 6, wherein said wax additive is a hydroxystearamide wax.

8. The insulation of claim 7, wherein the hydroxystearamide wax is N,N′ethylene-bis-12-hydroxy-stearamide.

9. A method of producing sound insulation having high loft, said method comprising steps of
adding a wax additive to a polypropylene resin to form a mixture, and then
extruding said mixture through nozzles onto a moving surface at a temperature and pressure such that a melt-blown fiber mass results.

10. The method of claim 9, wherein said temperature is about 230° C.

11. The method of claim 9, wherein said pressure is about 200 psi.

12. The method of claim 9, wherein said wax additive is a hydroxystearamide wax.

13. The method of claim 12, wherein the hydroxystearamide wax is N,N′ethylene-bis-12-hydroxy-stearamide.

14. The method of claim 13, wherein said temperature is about 230° C.

15. The method of claim 13, wherein said pressure is about 200 psi.

16. The method of claim 13, wherein the amount of said additive is no greater than 1.0% by weight of the amount of the resin.

17. The method of claim 13, wherein the amount of said additive is 0.4% to 0.6% by weight of the amount of the resin.
